(19) United States
(12) Patent Application Publication
(10) Pub. No.: US 2012/0303391 A1
(43) Pub. Date: Nov. 29, 2012

(54) METHOD AND SYSTEM FOR ANALYZING INSURANCE CONTRACTS AND INSURANCE CONTRACT PORTFOLIOS

(75) Inventors: Timo Tapio Salminen, Helsinki (FI); Osmo Visa Viktor Jauri, (US)

(73) Assignee: MODEL IT LTD, Helsinki (FI)

(21) Appl. No.: 13/476,173

(22) Filed: May 21, 2012

Related U.S. Application Data
(60) Provisional application No. 61/489,763, filed on May 25, 2011.

(51) Int. Cl. G06Q 40/08

(52) U.S. Cl. 705/4

(57) ABSTRACT

Systems, methods and computer program products for analyzing stochastic characteristics, including one or more subsystem for forecasting financial statements and financial ratios' probability distributions and configured for at least one of: analyzing insurance contracts and portfolios without simplifying contract and product terms and conditions; studying and illustrating financial statement probability distributions; analyzing insurance portfolios by creating net asset value distributions thereof without deterministic assumptions; modeling to support asset and liability management, wherein both assets and liabilities are simulated simultaneously and decisions are based on joint probability distributions thereof; and modeling to study effects of model specification changes by implementing new model definitions and by rerunning the model with constant random number generator seed.

### CROSS REFERENCE TO RELATED DOCUMENTS

The present invention is related to U.S. Provisional Patent Application Ser. No. 61/489,763 of SALMINEN et al., entitled “METHOD AND SYSTEM FOR ANALYZING INSURANCE CONTRACTS AND INSURANCE CONTRACT PORTFOLIOS,” filed on May 25, 2011, the entire disclosure of which is hereby incorporated by reference herein.

### BACKGROUND OF THE INVENTION

1. Field of the Invention

The present invention generally relates to analyzing stochastic characteristics of individual insurance contracts, portfolios consisting of those and related business. More particularly the invention include a method and system for finding non-simplified probability distributions of relevant variables, like cash-flows, insurance premiums, profit/loss, and financial ratios, including for example, return on equity.

2. Discussion of the Background

Traditionally, insurance contract and contract portfolio analysis has been based on one or more simplifying assumptions. However, existing systems and methods for insurance contract, contract portfolio and insurance business analysis do not adequately account for risks, nor the measuring and managing of insurance risks. Therefore, there is a need for a method and system for insurance contract, contract portfolio and insurance business analysis that address the above and other problems and risks, provide better and completely new information and provide new possibilities for measuring and managing insurance risk.

### SUMMARY OF THE INVENTION

The above and other needs are addressed by embodiments of the present invention, which provide a system and method for insurance risk analysis, including the analysis of single contracts, contract portfolios, or larger business entities, including investment assets and corporate financial planning. The system and method include building a company level planning model that utilizes results from stochastic analysis. The model allows external capital market simulations to be included in the analysis, and a joint simulation of both sides of balance sheet, yielding to new possibilities in asset and liability management.

In illustrative aspects, there are provided systems, methods and computer program products for analyzing stochastic characteristics, including one or more subsystem for forecasting financial statements and financial ratios' probability distributions and configured for at least one of: analyzing insurance contracts and portfolios without simplifying contract and product terms and conditions; studying and illustrating financial statement probability distributions; analyzing insurance portfolios by creating net asset value distributions thereof without deterministic assumptions; modeling to support asset and liability management, wherein both assets and liabilities are simulated simultaneously and decisions are based on joint probability distributions thereof; and modeling to study effects of model specification changes by implementing new model definitions and by rerunning the model with constant random number generator seed.

The system models risk by running pseudo- and/or quasi-number simulations on desired variables based on their distributions, including for example occurrence of death, disability and contract surrender. The number of simulations is set freely and for example can be in a typical analysis 1,000 or 10,000, and the like.

Advantageously, companies are able to measure the true market consistent value of their contracts and portfolios, measure probability distributions of relevant variables, combine analysis with external capital market simulations, and base their financial planning on these results.

Accordingly, in one aspect, a system for running stochastic analysis on contract level with non-simplified contract terms is provided. By doing this the system is not subject to any simplifications that would inherent model risk.

In another aspect, it is a system for defining probability distributions of desired variables over the time-period chosen for the analysis, for the purpose of analyzing single contract, contract portfolio or entire company. These variables include, for example, insurance premiums and claims, profit/loss, return on equity, or solvency indicators. The system also offers tools to predict probability levels for cash-flows and cumulative cash-flows that can be used to measure liquidity and insolvency risks of the company.

In another aspect, it is a system to define market consistent economic values of insurance contracts and portfolios by providing probability distributions for contract and portfolio net asset values.

In another aspect, the system provides tools and methods to create forecasts for other desired company data than assets and insurance liabilities. Other company data refers to any data employed to forecast company's financial statements and other desired financial data including volume indicators. In a typical model, these might include forecasts for running costs, investments, depreciations, loan margins and number of personnel.

In another aspect it is a system that enables company level financial planning. The system can include methods to create economic scenario (Economic Scenario Generator, ESG), or ESGs can externally created and read into to the system as input. ESGs commonly consist of simulated realizations of various capital market related and economic variables. Such variables commonly include, but are not restricted to stock market data, yield curve data, bonds segment data, credit spread data, inflation rates, currency rates, commodity prices and any relevant data affecting the value of company's assets and liabilities. ESG data affects asset values in the system and when combined with insurance risk simulation it is possible to have both sides of the balance sheet simultaneously in analysis. This enables efficient asset and liability management and also enables financial planning based on combined financial ratios and their distributions. During the analysis the system builds, at defined times, simulated balance sheets and income statements and allows decisions rules to be applied based on these results. Decision rules are company specific rules that may change the course of the simulation, typically by changing dividend decisions or by altering investment allocation base on for example simulated financial indicators. Each decision following from a decision rule can be made simulation round specific.

Still other aspects, features, and advantages of the present invention are readily apparent from the following detailed description, simply by illustrating a number of illustrative embodiments and implementations, including the best mode contemplated for carrying out the present invention. The present invention is also capable of other and different embodiments, and its several details can be modified in various respects, all without departing from the spirit and scope of the present invention. Accordingly, the drawings and descriptions are to be regarded as illustrative in nature, and not as restrictive.

### BRIEF DESCRIPTION OF THE DRAWINGS

The embodiments of the present invention are illustrated by way of example, and not by way of limitation, in the figures of the accompanying drawings and in which like reference numerals refer to similar elements and in which:

FIG. 1 is an overview of financial planning of an insurance company;

FIG. 2 is an overview of simulation;

FIG. 3 is an example on how simulation results can be represented and visualized on aggregate level; and

FIG. 4 is an example on how simulation results can be visualized on contract level.

### DETAILED DESCRIPTION OF THE INVENTION

A stochastic insurance risk simulator system and method is described. In the following description, for purposes of explanation, numerous specific details are set forth in order to provide thorough understanding of the present invention. It is apparent to one skilled in the art, however, that the present innovation may be predicted without these specific details or with equivalent arrangement. In some instances, well-known structures and devices are shown in figures and diagrams in order to avoid unnecessarily obscuring the present invention.

The present invention includes recognition that traditionally insurance contract and contract portfolio analysis has been based on one or more of the following simplifying assumptions: True contract portfolio is replaced by aggregate representations of underlying contracts, where the number of contracts is reduced and/or the aggregated contracts simplify true underlying contracts; True contract portfolio is replaced by replicating portfolio having less complexity than the original portfolio, where replicating portfolio consists typically simple financial instruments, like cash-flows, bonds and options; True stochastic behavior is, partly or in whole, replaced by deterministic assumptions, an example being assuming that all claims appear as defined by their deterministic properties, for example, claims to be paid in the future include no uncertainty in magnitude or timing; Some of the actual contracts terms are neglected or simplified in order to make the analysis faster or easier to do;

Insurance companies have been tempted to use these simplifications, since i) insurance contracts may have long time horizons, up to 70 years, ii) contracts include various kind of options given both to policy holders and the company itself, which both can make the analysis of even a single contract very time consuming Examples of these embedded options include the right make additional payments on a contract that has a guaranteed minimum level of return, and the right to postpone agreed retirement date and extend the running contract for a longer period in pension insurance. The employed amount of effort an insurance undertaking needs to put in analyzing its contract portfolio grows as the number of contracts and different products grow. As an example, a life insurance company may have 1 million contracts running on average for 30 years, indicating tens of millions of cash-flows to take place.

As a result from the complexity of the problem and the amounts of contracts and data, companies and supporting software and model vendors have used simplifications to make the analysis practical. As an example, in some models the analysis is first run as a deterministic model, where for example cash flows are assumed to be known. Then, in a later stage, stochastic behavior is added to the model by making the net present values of these cash-flows random by introducing stochastic interest rates. In such analysis, the insurance risk, for example, the risk of magnitude and timing of claims and other cash flows is completely omitted and randomness follows only from capital market randomness.

Yet another problem has been on how to combine insurance portfolio analysis with asset liability management and corporate planning Inadequate quality and independent computation modules invalidate results in both asset and liability management and capital adequacy planning.

Companies are more and more aware on the importance of proper risk analysis and recognize model risks taken by traditional lines of analysis. The pitfalls and omissions in existing technologies provide inadequate and misrepresenting information.

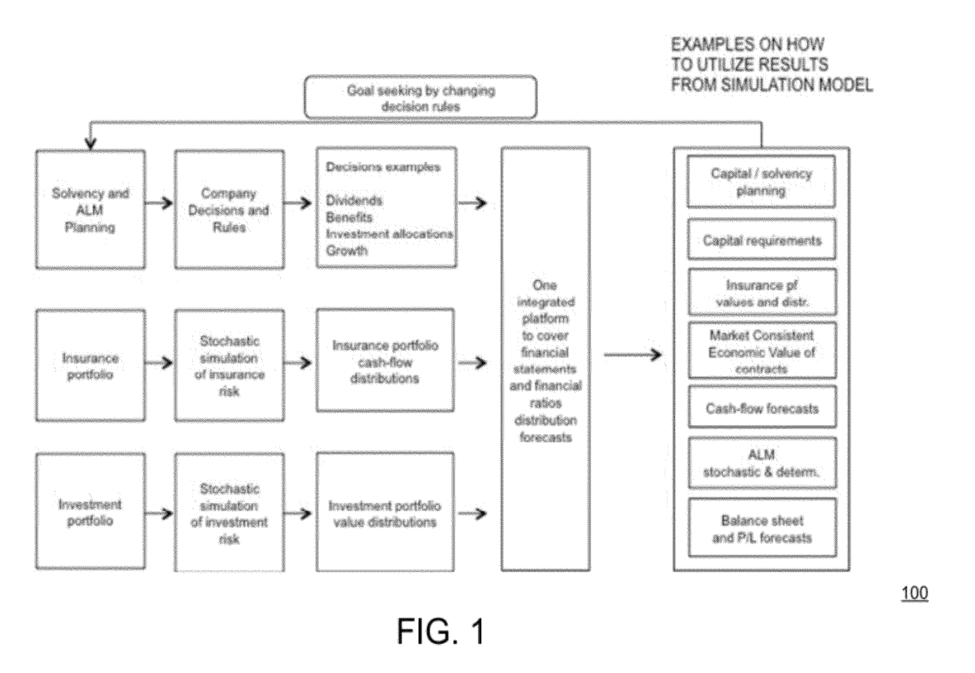

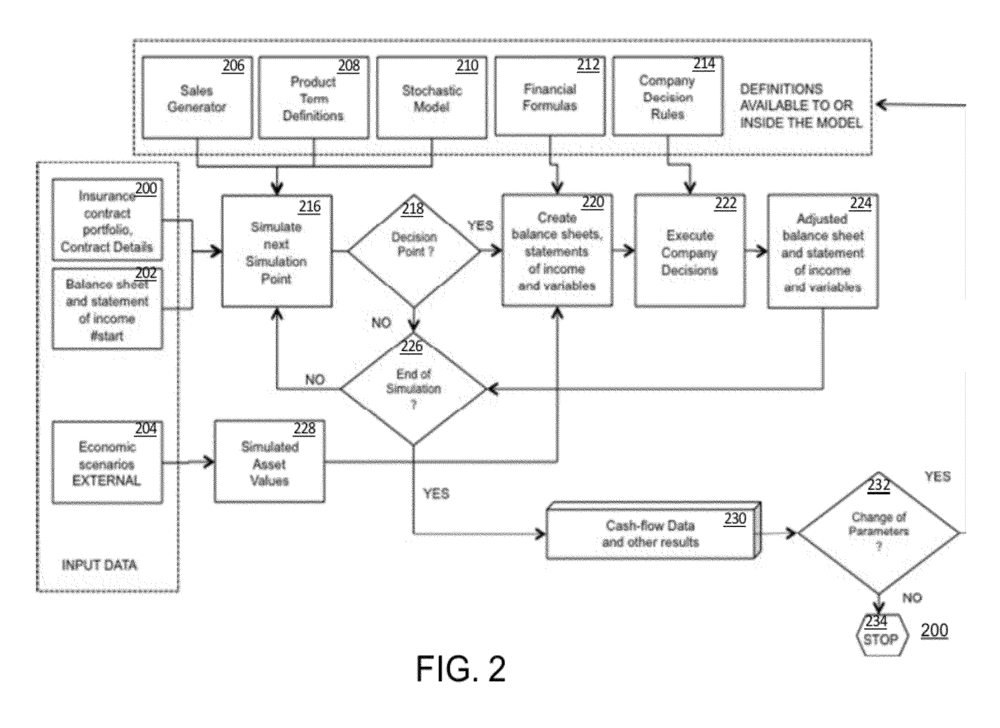

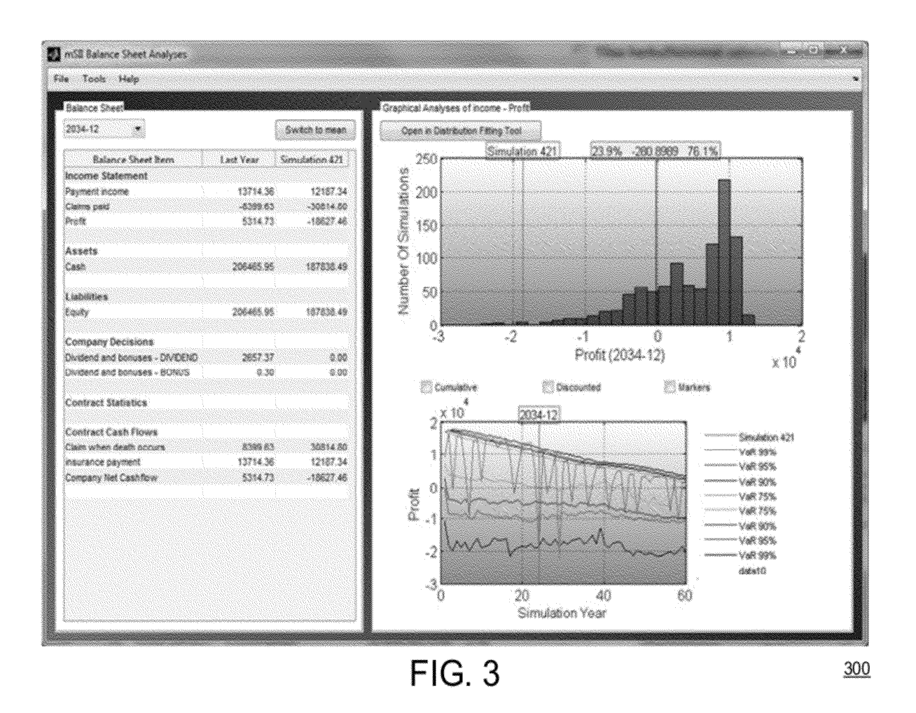

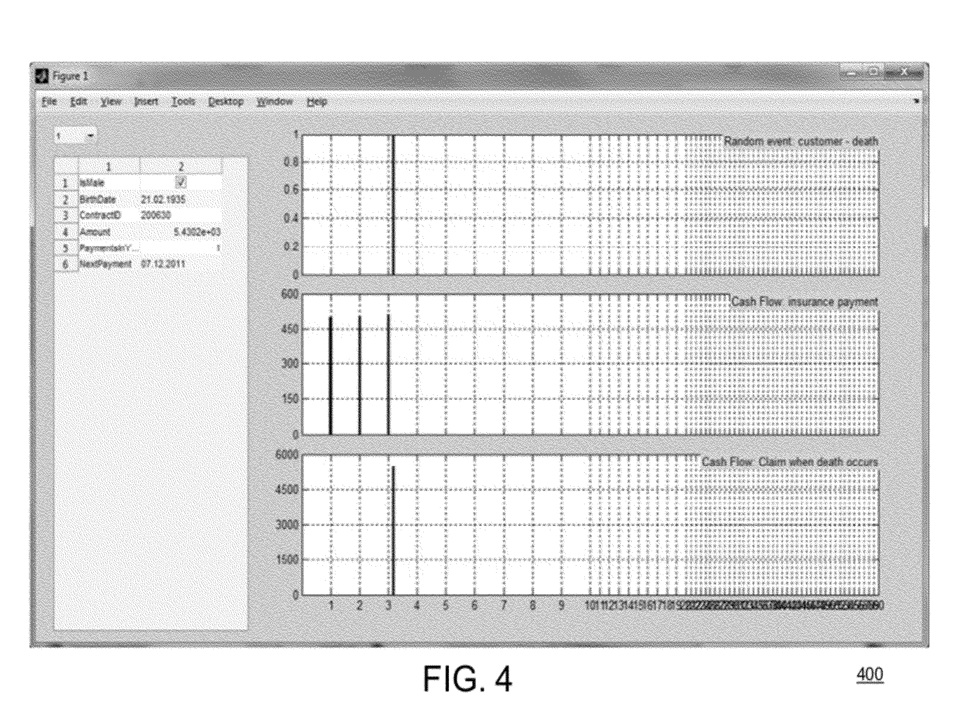

Referring now to the drawings, wherein like reference words designate identical or corresponding parts throughout the several views, FIG. 1 is an overview of financial planning of an insurance company; FIG. 2 is an overview of simulation; FIG. 3 is an example on how simulation results can be represented and visualized on aggregate level; and FIG. 4 is an example on how simulation results can be visualized on contract level.

The relationship between an insured and the insurance undertaking is assumed to be defined in applicable insurance contract terms and contracts details of the insured. Contract Terms refers to terms common to all policyholders holding such a contract and they are described in the model as an agreement of exchanging cash flows between the company and the insured (Product Term Definitions, 208). Cash-flows present in the model may be deterministic or stochastic in nature, both in timing and in magnitude. They may occur once or multiple times or may not appear in single simulation round at all. As an example, a typical life insurance contract may consist of recurring deterministic premium payments to the company and a stochastic claim payment from the company in the occurrence of death.

Particular details for each insured and contract are read into to model from external source (Contract Details, 200). Contract details can affect variables and cash-flows in the system. Typical examples of such a detail include, but not restrict to date of birth, insurance premium and insured amount.

A Sales Generator (206) is functionality that creates new insurance contracts that one assumes to appear in the future. Sales Generator (206) can be used to renew expiring contracts or it can be used to reflect various sales targets in various products. By changing the parameters of the Sales Generator (206) the user may study the impacts of these changes. A typical way to run an analysis would be test various growth scenarios and observe their differences in financial indicators, balance sheets and other results.

The model includes stochastic and deterministic variables and variables computed based on those. In the model states of variables are determined in discrete points of time, Simulation Points (216), where the interval in between, the time-step, can be constant or changing. In a typical simulation time-step can vary from 1 month to 5 years.

Simulation refers to a method where the same task is repeated multiple times with varying input to learn system characteristics. A typical way to do simulation is to use random number generator to create sequences of random numbers (pseudo-random numbers). Simulation can also be based on deterministic numbers, where numbers have been created in a non-random way (quasi-random numbers) or can be a combination of these.

Randomness is presented in the system by introducing a set of probability distributions and/or stochastic processes that will have numerical realizations in the simulation based on pseudo- or quasi-random numbers (Stochastic Model, 210). A typical analysis, for example, may create 1,000 or 10,000 realizations (Simulation Rounds) for each variable and for each Simulation Point (216). Randomness is also presented in the form of external Economic scenarios (204) and computed or otherwise deducted Simulated Asset Values (228) are based on those.

Stochastic variables in the system may or may not be mutually correlated or otherwise dependent.

Company Decisions (222) are based on defined Company Decision Rules (214). Company Decision Rules (214) reflect any state dependent change that is employed to take place in the simulation. Rules are applied to each Simulation Round separately. Typical examples of Company Decision Rules (214) are rules to define the amount of dividends a company would pay or changes in asset portfolio weights based on, for example, financial indicators like return on equity or profitability.

In the model Decision Points (218), if any, are special Simulation Points (216), where simulation state dependent decisions can alter the course of simulation (Execute Company Decisions, 222). In a typical analysis one may define that after 12 months there will be Decision Point (218), where simulated and calculated variables are organized in the form of balance sheet, income statement and desired financial indicators, including for example solvency status, return on equity and profit/loss, based on Simulation Points (216), Simulated Asset Values (228) and Financial Formulas (212). Decision Rules (214) may use these results and other data and based on the rules a Company Decision (222) may take place. The rules for organizing variables and computing new variables are referred as Financial Formulas (212). As a clarifying example, in a typical simulation there might be a Decision Point (216) each year in 70 year simulation and for each of those Decision Points (218) financial statements (220) are created for each Simulation Round based on Financial Formulas (212). Company Decision (222) affects the simulation by changing values of variables (224). Examples of such changes include changes in dividend policy, decisions on future benefits or changes in investment portfolio.

Simulation is carried out until the final time step is reached (226) and simulation ends. If no further planning is made by changing parameters (232) the use of the model stops (234). If changes are needed, the user adjusts definitions (206, 208, 210, 212, 214) and/or selects new data sets from insurance portfolio (200) or economic scenario generator (204) or assumes new values for starting point (202).

The output of the simulation model consists of deterministic and simulation based cash-flows, which can be reported in desired dimensions (Cash-flow Data, 230). As a clarifying example, in a typical analysis one may report results in a form of 3-dimensional Cash-flow Cube, where one dimensions is cash-flow type, one is Simulation Round and one Simulation Step. Results also include all other variables and calculations perform during Simulation, examples including balance sheet, statement of income and financial ratios.

The model enables the user to predict financial data and associated probability distributions. Financial planning is supported, when the user can modify Company Decision Rules (214) and other assumptions and definitions in the model (206, 208, 210, 212, 204). A typical example of such activity is testing of various dividend policies or investment strategies against results provided by the model by Changing Parameters (232).

The computer system used to run the simulation model may consist of a single workstation having necessary connections to read Input Data, where the workstation can equally be a server, laptop computer or mainframe computer. The simulation may be divided among several processors and several computation cores in a workstation. Some parts of actual computations may be performed by dedicated devices, including Graphical Processing Units. Simulation tasks may also be performed by external servers or may be distributed among a set of computers communicating with each other by using local-area-network, wide-area-network, wireless-local-area-network or other way supporting employed change of information. The structure of such computation network is not limited to predefined sets of computers or virtual computers, but can equally consist of a computer cloud offering computation services in a non-predefined hardware configuration.

The computer system may or may not communicate with one or more database servers offering access to contract and other input data, and provide services to store any results or information deducted from results.

Accordingly, in FIG. 1, is presented an overview of an insurance taking's planning process. Key elements include asset value simulation, insurance liability portfolio valuation and upper level solvency and ALM planning. When results from asset value simulation and insurance liability simulation are combined in one model one is able to create simulated financial statements and financial ratios, with their probability distributions. This information is utilized in interactive planning process where management seeks preferred decision rules and growth targets.

In FIG. 2, is presented the components and steps employed to produce forecasts for financial statement distributions. The model reads input data (200, 202, 204) and starts simulation based on Stochastic Model (210). Product Terms and Definitions (208) affect the way cash flows appear in the model. Sale Generator (206) may be used to create new sales. Simulation (216) is run Simulation Step by Simulation Step until Decision Point (218) is reached. In decision Point financial statements and rations (220) are generated from simulated and forecasted data and Company Decision Rules (214) may be applied to change the course of simulation. Company Decision Rules (214) can be applied separately for each Simulation Round. If the simulation hasn't reached the final step, simulation continues again until a new Decision Point (218) or Simulation end (226) is reached. If one wishes to change model parameters, the simulation can be rerun. As en example, in excess to changes in decision rules, one might want to study the effects of making changes in the Stochastic Model (210), where an example would be to study impact of a mortality shock in life insurance. By keeping the random number generator's seed constant, one is able to measure the affect of the model change without noise from using different set of random numbers.

In FIG. 3, is presented an example how the results can be illustrated at aggregate level. One is able to study characteristics of forecasted distribution by drawing graphical representations of distributions, by reporting statistical indicators like averages, by showing developments in the probability distribution by drawing preferred quantiles of distributions (referred as VAR levels in FIG. 3).

In FIG. 4, is presented another example where a single contract simulation is illustrated with graphical user interface, where all cash-flows and random events are simultaneously represented in along the time axes. A market in the graph indicates for cash-flows their magnitude and for random variables and stochastic processes their state.

The above-described devices and subsystems of the illustrative embodiments can include, for example, any suitable servers, workstations, PCs, laptop computers, PDAs, Internet appliances, handheld devices, cellular telephones, wireless devices, other devices, and the like, capable of performing the processes of the illustrative embodiments. The devices and subsystems of the illustrative embodiments can communicate with each other using any suitable protocol and can be implemented using one or more programmed computer systems or devices.

One or more interface mechanisms can be used with the illustrative embodiments, including, for example, Internet access, telecommunications in any suitable form (e.g., voice, modem, and the like), wireless communications media, and the like. For example, employed communications networks or links can include one or more wireless communications networks, cellular communications networks, G3 communications networks, Public Switched Telephone Network (PSTNs), Packet Data Networks (PDNs), the Internet, intranets, cloud computing networks, a combination thereof, and the like.

It is to be understood that the described devices and subsystems are for illustrative purposes, as many variations of the specific hardware used to implement the illustrative embodiments are possible, as will be appreciated by those skilled in the relevant art(s). For example, the functionality of one or more of the devices and subsystems of the illustrative embodiments can be implemented via one or more programmed computer systems or devices.

To implement such variations as well as other variations, a single computer system can be programmed to perform the special purpose functions of one or more of the devices and subsystems of the illustrative embodiments. On the other hand, two or more programmed computer systems or devices can be substituted for any one of the devices and subsystems of the illustrative embodiments. Accordingly, principles and advantages of distributed processing, such as redundancy, replication, and the like, also can be implemented, as desired, to increase the robustness and performance of the devices and subsystems of the illustrative embodiments.

The devices and subsystems of the illustrative embodiments can store information relating to various processes described herein. This information can be stored in one or more memories, such as a hard disk, optical disk, magneto-optical disk, RAM, and the like, of the devices and subsystems of the illustrative embodiments. One or more databases of the devices and subsystems of the illustrative embodiments can store the information used to implement the illustrative embodiments of the present inventions. The databases can be organized using data structures (e.g., records, tables, arrays, fields, graphs, pigeons, trees, lists, and the like) included in one or more memories or storage devices listed herein. The processes described with respect to the illustrative embodiments can include appropriate data structures for storing data collected and/or generated by the processes of the devices and subsystems of the illustrative embodiments in one or more databases thereof.

All or a portion of the devices and subsystems of the illustrative embodiments can be conveniently implemented using one or more general purpose computer systems, microprocessors, digital signal processors, micro-controllers, and the like, programmed according to the teachings of the illustrative embodiments of the present inventions, as will be appreciated by those skilled in the computer and software arts. Appropriate software can be readily prepared by programmers of ordinary skill based on the teachings of the illustrative embodiments, as will be appreciated by those skilled in the software art. Further, the devices and subsystems of the illustrative embodiments can be implemented on the World Wide Web. In addition, the devices and subsystems of the illustrative embodiments can be implemented by the preparation of application-specific integrated circuits or by interconnecting an appropriate network of conventional component circuits, as will be appreciated by those skilled in the electrical art(s). Thus, the illustrative embodiments are not limited to any specific combination of hardware circuitry and/or software.

Stored on any one or on a combination of computer readable media, the illustrative embodiments of the present inventions can include software for controlling the devices and subsystems of the illustrative embodiments, for driving the devices and subsystems of the illustrative embodiments, for enabling the devices and subsystems of the illustrative embodiments to interact with a human user, and the like. Such software can include, but is not limited to, device drivers, firmware, operating systems, development tools, applications software, and the like. Such computer readable media further can include the computer program product of an embodiment of the present inventions for performing all or a portion (if processing is distributed) of the processing performed in implementing the inventions. Computer code devices of the illustrative embodiments of the present inventions can include any suitable interpretable or executable code mechanism, including but not limited to scripts, interpretable programs, dynamic link libraries (DLLs), Java classes and applets, complete executable programs, Common Object Request Broker Architecture (CORBA) objects, and the like. Moreover, parts of the processing of the illustrative embodiments of the present inventions can be distributed for better performance, reliability, cost, and the like.

As stated above, the devices and subsystems of the illustrative embodiments can include computer readable medium or memories for holding instructions programmed according to the teachings of the present inventions and for holding data structures, tables, records, and/or other data described herein. Computer readable medium can include any suitable medium that participates in providing instructions to a processor for execution. Such a medium can take many forms, including but not limited to, non-volatile media, volatile media, transmission media, and the like. Non-volatile media can include, for example, optical or magnetic disks, magneto-optical disks, and the like. Volatile media can include dynamic memories, and the like. Transmission media can include coaxial cables, copper wire, fiber optics, and the like. Transmission media also can take the form of acoustic, optical, electromagnetic waves, and the like, such as those generated during radio frequency (RF) communications, infrared (IR) data communications, and the like. Common forms of computer-readable media can include, for example, a floppy disk, a flexible disk, hard disk, magnetic tape, any other suitable magnetic medium, a CD-ROM, CDRW, DVD, any other suitable optical medium, punch cards, paper tape, optical mark sheets, any other suitable physical medium with patterns of holes or other optically recognizable indicia, a RAM, a PROM, an EPROM, a FLASH-EPROM, any other suitable memory chip or cartridge, a carrier wave or any other suitable medium from which a computer can read.

The systems and methods of FIGS. 1-4 can employ object oriented model definitions, wherein with a suitable toolbox users need not write any procedural program code, but rather can define variables that exist in a given model and provide technical instructions for the simulation thereof, by employing the teachings of the present invention, as will be appreciated by those of ordinary skill in the relevant art(s).

Although the systems and methods of FIGS. 1-4 are described in terms of being employed for contracts, and the like, the systems and methods of FIGS. 1-4 can be employed with other types of applications, such as stock market applications, banking applications, and the like, where modeling and analytics are advantageous, by employing the teachings of the present invention, as will be appreciated by those of ordinary skill in the relevant art(s).

While the present inventions have been described in connection with a number of illustrative embodiments, and implementations, the present inventions are not so limited, but rather cover various modifications, and equivalent arrangements, which fall within the purview of the appended claims.

What is claimed is:

1. A system for analyzing stochastic characteristics, comprising:
one or more subsystems for forecasting financial statements and financial ratios' probability distributions and configured for:
analyzing insurance contracts and portfolios without simplifying contract and product terms and conditions;
studying and illustrating financial statement probability distributions;
analyzing insurance portfolios by creating net asset value distributions thereof without deterministic assumptions;
modeling to support asset and liability management, wherein both assets and liabilities are simulated simultaneously and decisions are based on joint probability distributions thereof; and
modeling to study effects of model specification changes by implementing new model definitions and by rerunning the model with constant random number generator seed.

2. A method for analyzing stochastic characteristics with one or more subsystems for forecasting financial statements and financial ratios' probability distributions, comprising the steps of.
analyzing insurance contracts and portfolios without simplifying contract and product terms and conditions;
studying and illustrating financial statement probability distributions;
analyzing insurance portfolios by creating net asset value distributions thereof without deterministic assumptions;
modeling to support asset and liability management, wherein both assets and liabilities are simulated simultaneously and decisions are based on joint probability distributions thereof; and
modeling to study effects of model specification changes by implementing new model definitions and by rerunning the model with constant random number generator seed.

3. A computer program product including tangible, non-transitory computer readable instructions for analyzing stochastic characteristics with one or more subsystems for forecasting financial statements and financial ratios' probability distributions and configured to cause one or more computer processors to perform the steps of:
analyzing insurance contracts and portfolios without simplifying contract and product terms and conditions;
studying and illustrating financial statement probability distributions;
analyzing insurance portfolios by creating net asset value distributions thereof without deterministic assumptions;
modeling to support asset and liability management, wherein both assets and liabilities are simulated simultaneously and decisions are based on joint probability distributions thereof; and
modeling to study effects of model specification changes by implementing new model definitions and by rerunning the model with constant random number generator seed.
